(19) United States
(12) Patent Application Publication
(10) Pub. No.: US 2025/0182063 A1
(43) Pub. Date: Jun. 5, 2025

(54) System and method of intelligent vehicle

(71) Applicant: Mourad Ben Ayed, Fremont, CA (US)

(72) Inventor: Mourad Ben Ayed, Fremont, CA (US)

(21) Appl. No.: 18/528,825

(22) Filed: Dec. 5, 2023

(51) Int. Cl. G06Q 10/20

(52) U.S. Cl. CPC G06Q 10/20

(57) ABSTRACT

A system for intelligently servicing motor vehicles is provided comprising a computer that detects at least one issue with a vehicle necessitating service. The system obtains availability options for the service from a service scheduler of a first dealer designated as default dealer for the vehicle or selected by an owner of the vehicle. The system contacts the owner notifying of need for service and presents options for service appointment. Based on a response from the owner, the system books the appointment in the service scheduler. The system detects the at least one issue based on at least one of communication with components of the vehicle, contact with a service scheduling function associated with the vehicle, and on learning of a manufacturer recall for the vehicle. The computer is at least one of installed in the vehicle and installed remotely from the vehicle.

### CROSS REFERENCE TO RELATED APPLICATIONS

None

### FIELD OF THE DISCLOSURE

The present disclosure is in the field of motor vehicle maintenance and care. More particularly, the present disclosure provides an onboard or remote system that monitors vehicle systems, arranges service with authorized providers, contacts vehicle owners with appointment information, confirms appointment with owners, and arranges transportation on the day of appointment.

### BACKGROUND

Vehicle owners often overlook the need for regular vehicle servicing such as oil changes, battery service, tune ups, brake maintenance, and tire servicing. Many owners do not track the time since previous service and do not regularly check fluid levels and tire condition. Owners also often do not recognize or disregard a developing problem. Some vehicle problems are difficult or impossible to recognize, diagnose, or predict. Some vehicle owners knowingly disregard problems in the hope a problem will just go away.

Ignoring a need for service or disregarding a developing problem can involve significant expense. Worse, such negligence can result in safety hazards to a vehicle owner, passengers, other motorists, pedestrians, or property.

### BRIEF DESCRIPTION OF THE FIGURE

FIG. 1 is a block diagram of a system of an intelligent vehicle in accordance with an embodiment of the present disclosure.

### DETAILED DESCRIPTION

Systems and methods described herein provide an electronic device that determines that a vehicle is due for regular service or needs emergency service. The device contacts a service provider, receives appointment dates and time, and confirms a selected appointment after contacting the vehicle's owner. The device assists the owner with transportation before and during the servicing period to reduce inconvenience to the owner.

The device may be located aboard the vehicle or may be located remotely from the vehicle. In an embodiment, the device may provide the services described herein to more than one vehicle. While the device may receive messaging from sensors or other detection components and take action based thereon, the device may also take action to arrange servicing based on receiving communication from a service scheduling function for the vehicle and/or upon learning of a manufacturer recall for the vehicle.

A service provider contacted by the device may be designated as default dealer for the vehicle or may have been selected by the vehicle owner. The device obtains the identity and contact details from vehicle information, for example the title, registration, or an online record. If the vehicle's driver or regular user is different from the owner and the driver can be contacted, the system may contact the driver to obtain the owner's information. The system may determine that the vehicle has changed title by at least contacting the department of motor vehicles (DMV) for the state or other agency.

The system is designed to provide personalized service to the vehicle owner. The system gathers possible dates and times for appointments from the dealer designated or selected as described above and presents the candidate appointments to the owner. The system books the appointment chosen by the owner and confirms the booked appointment back to the owner.

A loaner vehicle is offered to the owner for use while the owner's vehicle is receiving service, a benefit particularly if the service requires several days. The owner is asked during notification of the appointment booking if either mobility services or service at the service center is preferred. The system may communicate with the owner of the vehicle via the vehicle's entertainment system, via SMS message, via an app, and/or via a voice call.

The system may also attempt to book service appointments for optional service. Optional service potentially involves longer service time than time required for necessary or emergency service.

The system may determine that previously declined services are pending and obtains time slots for such services. The system provides options to the owner with advice to the owner that receiving previously declined services potentially involves greater off-time and cost compared to services not previously declined.

The present disclosure provides various methods for intelligently providing vehicle service. In one method, the device receives a request for service entered via an interface accessible in a vehicle dashboard. The device contacts a default dealer for service, receives available time slots for service, and displays the time slots on the interface. Based on receiving a selection of a first time slot of the displayed time slots, the device books an appointment for the requested service.

The device does not need a year, make and model number of the vehicle to complete the booking. The device requests the driver or owner to choose from appointment-related transportation options. The options include vehicle drop-off options, loaner vehicle options, and arrangements with rideshare providers. The system may alternatively advise the driver that appointment-related transportation options are not available based on a determination that the vehicle is no longer under warranty.

The device tries to obtains the owner information for the service booking from memory. If found, it can confirm it with the driver or owner. The device can also request the driver or owner to provide their first name and last name.

Another method provided herein comprises the device calling an application programming interface (API) for a dealership authorized to service a vehicle. The API is associated with availability of the dealership to perform service. The device requests a preferred service center, provides a service code, and enters year, make, and model of the vehicle.

The device obtains available appointment times for service. The device provides the appointment times to the owner or driver of the vehicle and booking an appointment time based on driver or owner selection. The device may alternatively call a centralized service with the centralized service calling a dealer availability API.

Before the appointment time comes, the device may alert the driver or owner. The device may also drive automatically to the service department using self-driving function.

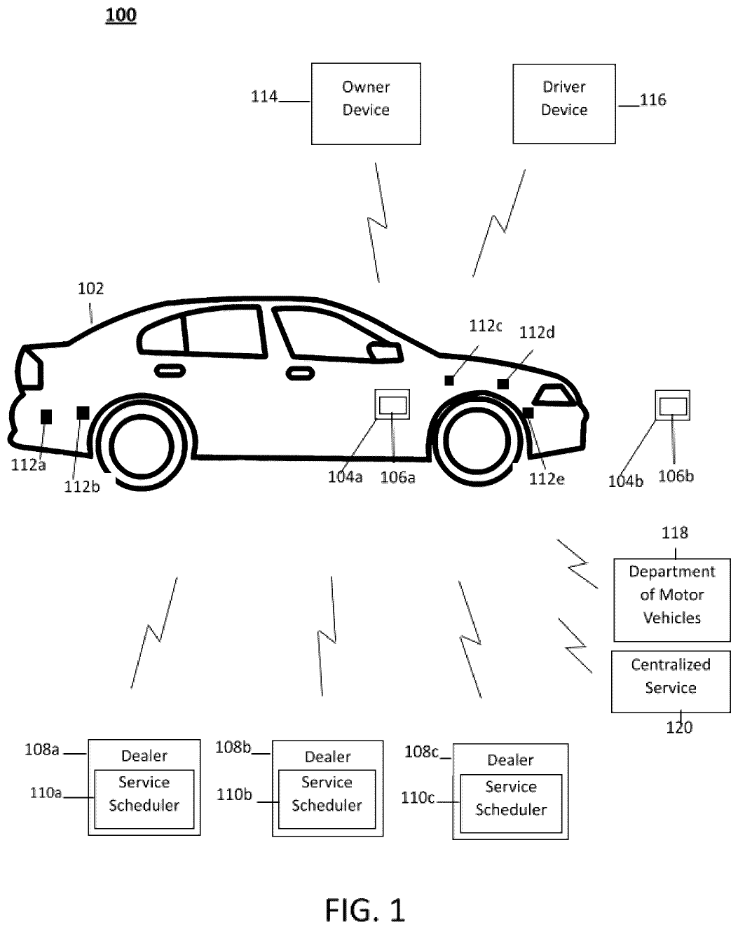

Turning to the FIGURE, FIG. 1 is a block diagram of a system of an intelligent vehicle in accordance with an embodiment of the present disclosure. Components and interactions of a system 100 are depicted in FIG. 1.

The system 100 comprises a vehicle 102 which may be an automobile, truck, bus or other wheeled vehicle. The system 100 comprises an intelligent vehicle device 104a-b and an intelligent vehicle application 106a-b executing thereon, referred to hereinafter for brevity as the device 104a-b and the application 106a-b. The device 104a and accompanying application 106a are installed in the vehicle 102. The device 104b and accompanying application 106b are not installed in the vehicle 102 and are instead remote from the vehicle 102. Unless otherwise noted, discussion of the device 104a-b and application 106a-b applies to both the onboard and remote embodiments of these components.

The system 100 also comprises dealers 108a-c and service scheduler applications 110a-c that may execute on computers at dealer sites. In embodiments, and while not represented in FIG. 1, service scheduler applications 110a-c may be operated by entities separate from dealers 108a-c under contract with dealers 108a-c, manufacturers, or other parties.

The system 100 also comprises sensors 112a-e situated at various locations in the vehicle 102 and monitoring systems therein. A view of the sample positioning of the sensors 112a-e suggests that sensor 112a may monitor an exhaust system and sensor 112b may monitor rear brakes. At the front of the vehicle 102, sensor 112c may monitor electrical systems, sensor 112d may monitor a fluid level, and sensor 112e may monitor front brakes. These are merely examples of placement and functionality of sensors 112a-e. Sensors 112a-e are positioned in FIG. 1 for illustration and discussion purposes and may be positioned elsewhere in various embodiments. In embodiments, the system 100 may have more than or less than quantity five sensors 112a-e.

The system 100 also comprises an owner device 114 and a driver device 116 that may be mobile devices, for example smartphones, carried by the owner and vehicle, respectively, of the vehicle 102. The system 100 further comprises the department of motor vehicles 118 and a centralized service 120.

The vehicle 102 is outfitted with wireless capabilities to communicate wirelessly with many of the other components provided by the system 100. When the remote device 104b and application 106b are in use, these components communicate wirelessly or in a wired fashion with many of the other components including the sensors 112a-e that communicate with the remote device 104b via wireless functionality in the vehicle 102.

1. A system for intelligently servicing motor vehicles, comprising:
a computer; and
an application stored in the computer that when executed:
detects at least one issue with a vehicle, the at least one issue necessitating service,
obtains availability options for the necessitated service from a service scheduler of a first dealer, the first dealer at least one of designated as default dealer for the vehicle and selected by an owner of the vehicle,
contacts the owner notifying of need for service and presenting options for service appointment, and
based on a response from the owner, books the appointment in the service scheduler.

2. The system of claim 1, wherein the system detects the at least one issue based on at least one of communication with components of the vehicle, contact with a service scheduling function associated with the vehicle, and on learning of a manufacturer recall for the vehicle.

3. The system of claim 1, wherein the computer is at least one of installed in the vehicle and installed remotely from the vehicle.

4. The system of claim 1, wherein the identity of the vehicle owner is obtained at least one of from vehicle information and from a driver of the vehicle.

5. The system of claim 1, wherein based on the system having determined that the vehicle has changed title, the system requests the owner to provide the owner's information.

6. The system of claim 5, wherein the system determines that the vehicle has changed title based at least on contact with a state department of motor vehicles.

7. The system of claim 1, wherein on the day the system books the appointment, the system notifies the owner.

8. The system of claim 7, wherein during notification the system further offers the owner availability of a loaner vehicle.

9. The system of claim 1, wherein the vehicle drives automatically to the first dealer.

10. The system of claim 1, wherein the owner is contacted via at least one of a vehicle entertainment system, an SMS message, an app, and a voice call.

11. The system of claim 1, wherein during notification the owner is asked if one of mobility services and service at a service center is preferred.

12. The system of claim 1, wherein obtaining availability options comprises obtaining time slots for needed service and for optional service and further comprises providing options to the owner, wherein optional service potentially involves longer service time than required for needed service.

13. The system of claim 1, wherein the system further determines that previously declined services are pending, obtains time slots for needed service, and provides options to the owner with advice to owner that receiving previously declined services potentially involves greater off-time and cost compared to services not previously declined.

14. A method for intelligently providing vehicle service, comprising:
a computer, via an interface accessible in a vehicle dashboard, receiving a request for service;
the computer contacting a default dealer for service, receiving available time slots for service, and displaying the time slots on the interface; and
the computer, based on receiving a selection of a first time slot of the displayed time slots, booking an appointment for the requested service.

15. The method of claim 14, further comprising the computer not needing a year, make and model number of the vehicle to complete the booking.

16. The method of claim 14, further comprising the computer requesting a driver of the vehicle to choose from appointment-related transportation options comprising at least one of vehicle drop-off options, loaner vehicle options, and arrangements with rideshare providers.

17. The method of claim 16, further comprising the computer alternatively advising the driver that appointment-related transportation options are not available based on a determination that the vehicle is no longer under warranty.

18. A method for automatically arranging vehicle servicing, comprising:
calling an application programming interface (API) for a dealership authorized to service a vehicle, the API associated with availability of the dealership to perform service;
requesting a preferred service center;
providing a service code and entering year, make, and model of the vehicle;
obtaining available appointment times for service;
providing the appointment times to a driver of the vehicle, and
booking a first appointment time based on driver selection.

19. The method of claim 18, further comprising receiving a time slot selected by the driver and calling a book API to book the time slot.

20. The method of claim 18, further comprising the computer calling a centralized service and the centralized service calling a dealer availability API.
